(19) United States
(12) Patent Application Publication
(10) Pub. No.: US 2017/0362501 A1
(43) Pub. Date: Dec. 21, 2017

(54) WAVELENGTH CONVERSION MATERIAL

(71) Applicant: NIPPON ELECTRIC GLASS CO., LTD., Otsu-shi, Shiga (JP)

(72) Inventors: Masaaki KADOMI, Otsu-shi (JP); Hideki ASANO, Otsu-shi (JP)

(21) Appl. No.: 15/541,384

(22) PCT Filed: Feb. 15, 2016
(86) PCT No.: PCT/JP2016/054253

§ 371 Date: Jul. 3, 2017

(30) Foreign Application Priority Data
Apr. 10, 2015 (JP) 2015-080613

(51) Int. Cl. C09K 11/02; F21V 9/16

(52) U.S. Cl. CPC C09K 11/025; F21V 9/16

(57) ABSTRACT

Provided is a wavelength conversion member that can improve the color balance of emitted light. A wavelength conversion member 1 includes a phosphor 2 encapsulated within a glass tube 10, wherein the glass tube 10 includes: a first flat-plate portion 11 and a second flat-plate portion 12 opposed to each other in a first direction (z direction) perpendicular to a longitudinal direction (y direction) of the glass tube 10; and a third flat-plate portion 13 and a fourth flat-plate portion 14 opposed to each other in a second direction (x direction) perpendicular to both the longitudinal direction (y direction) of the glass tube 10 and the first direction (z direction), the first flat-plate portion 11 is located on a light incident side of the glass tube 10 through which excitation light 3 for exciting the phosphor 2 enters the glass tube 10, the second flat-plate portion 12 is located on a light exit side of the glass tube 10 through which fluorescence 4 from the phosphor 2 is emitted from the glass tube 10, at least one of a first corner 21 connecting between the first flat-plate portion 11 and the third flat-plate portion 13 and a second corner 22 connecting between the first flat-plate portion 11 and the fourth flat-plate portion 14 is chamfered.

### TECHNICAL FIELD

The present invention relates to wavelength conversion members in which a phosphor is encapsulated within a glass tube.

### BACKGROUND ART

In recent years, much development has been made of white light sources, for use in backlights of liquid crystal displays or other uses, in which an LED (light emitting diode) for emitting a blue light and a wavelength conversion member are used. In such a white light source, a white light is emitted which is a synthesized light of the blue light emitted from the LED and then transmitting through the wavelength conversion member and a yellow light emitted from the wavelength conversion member.

It is proposed to use, in a wavelength conversion member, a glass tube as a container for encapsulating a phosphor (Patent Literature 1). Furthermore, studies have recently been made on quantum dots as a phosphor. For example, it has been studied to form a wavelength conversion member by introducing into a glass tube a fluid in which quantum dots are dispersed in a resin.

### CITATION LIST

### Patent Literature

[PTL 1]
JP-A-2012-163798

### SUMMARY OF INVENTION

### Technical Problem

The inventors found the problem that when an angular cylindrical glass tube is used as a glass tube for a wavelength conversion member, the color balance of light emitted from the wavelength conversion member deteriorates.

An object of the present invention is to provide a wavelength conversion member that can improve the color balance of emitted light.

### Solution to Problem

The present invention is directed to a wavelength conversion member in which a phosphor is encapsulated within a glass tube, the glass tube including: a first flat-plate portion and a second flat-plate portion opposed to each other in a first direction perpendicular to a longitudinal direction of the glass tube; and a third flat-plate portion and a fourth flat-plate portion opposed to each other in a second direction perpendicular to both the longitudinal direction of the glass tube and the first direction, the first flat-plate portion being located on a light incident side of the glass tube through which excitation light for exciting the phosphor enters the glass tube, the second flat-plate portion being located on a light exit side of the glass tube through which fluorescence from the phosphor is emitted from the glass tube, at least one of a first corner connecting between the first flat-plate portion and the third flat-plate portion and a second corner connecting between the first flat-plate portion and the fourth flat-plate portion being chamfered.

In the present invention, both the first corner and the second corner are preferably chamfered.

A third corner connecting between the second flat-plate portion and the third flat-plate portion and a fourth corner connecting between the second flat-plate portion and the fourth flat-plate portion may be chamfered.

An example of the phosphor that can be cited is quantum dots. In this case, the quantum dots are preferably encapsulated as a dispersion in a resin within the glass tube.

### Advantageous Effects of Invention

The present invention enables to improve the color balance of light emitted from the wavelength conversion member.

### BRIEF DESCRIPTION OF DRAWINGS

FIG. 1 is a schematic longitudinal cross-sectional view showing a wavelength conversion member according to one embodiment of the present invention.

FIG. 2 is a schematic transverse cross-sectional view taken along the line II-II in FIG. 1.

FIG. 3 is a schematic transverse cross-sectional view showing a conventional wavelength conversion member.

### DESCRIPTION OF EMBODIMENTS

Hereinafter, a description will be given of a preferred embodiment. However, the following embodiment is merely illustrative and the present invention is not intended to be limited to the following embodiment. Throughout the drawings, members having substantially the same functions may be referred to by the same reference characters.

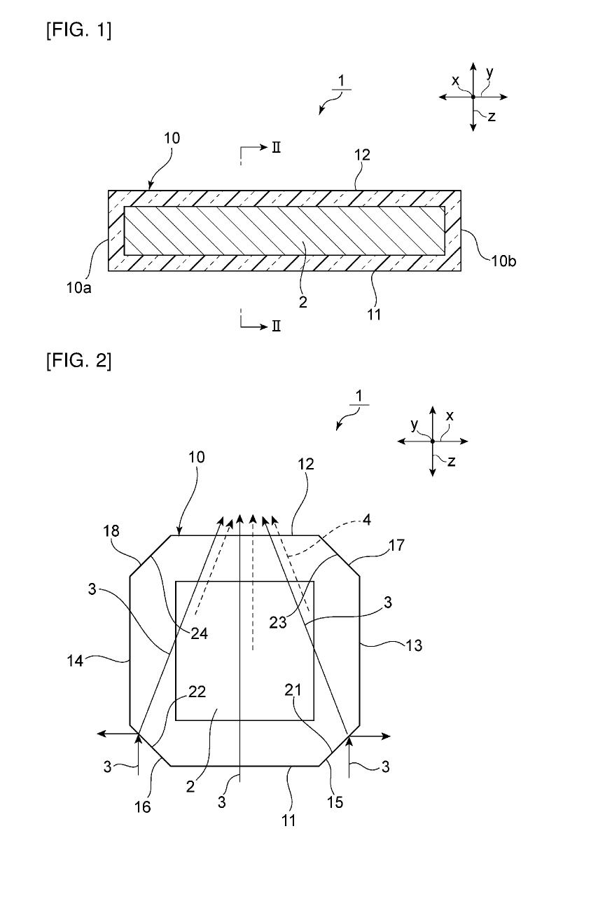

FIG. 1 is a schematic longitudinal cross-sectional view showing a wavelength conversion member according to one embodiment of the present invention. FIG. 2 is a schematic transverse cross-sectional view taken along the line II-II in FIG. 1. In FIG. 2, hatching to be applied to the cross-section is omitted. As shown in FIG. 1, a wavelength conversion member 1 according to this embodiment includes a glass tube 10 and a phosphor 2 encapsulated within the glass tube 10. One end 10a and the other end 10b of the glass tube 10 in the longitudinal direction (y direction) are sealed by fusing the glass tube 10. However, the present invention is not limited to this and, for example, the ends 10a and 10b may be sealed with separate members.

As shown in FIG. 2, the glass tube 10 includes a first flat-plate portion 11 and a second flat-plate portion 12 opposed to each other in a first direction (z direction) perpendicular to the longitudinal direction (y direction) of the glass tube 10. Also, the glass tube 10 further includes a third flat-plate portion 13 and a fourth flat-plate portion 14 opposed to each other in a second direction (x direction) perpendicular to both the longitudinal direction (y direction) of the glass tube 10 and the first direction (z direction). As shown in FIG. 2, the glass tube 10 in this embodiment has an angular cylindrical shape. The first flat-plate portion 11 is located on a light incident side of the glass tube through which excitation light 3 for exciting the phosphor 2 enters the glass tube, while the second flat-plate portion 12 is located on alight exit side of the glass tube through which fluorescence 4 from the phosphor 2 is emitted from the glass tube.

As shown in FIG. 2, a first corner 21 connecting between the first flat-plate portion 11 and the third flat-plate portion 13 is formed with an inclined surface 15, that is, the first corner 21 is chamfered. Likewise, a second corner 22 connecting between the first flat-plate portion 11 and the fourth flat-plate portion 14 is formed with an inclined surface 16, that is, the second corner 22 is chamfered. Furthermore, a third corner 23 connecting between the second flat-plate portion 12 and the third flat-plate portion 13 is formed with an inclined surface 17, that is, the third corner 23 is chamfered. Likewise, a fourth corner 24 connecting between the second flat-plate portion 12 and the fourth flat-plate portion 14 is formed with an inclined surface 18, that is, the fourth corner 24 is chamfered.

Although no particular limitation is placed on the dimensions of the glass tube 10, for example, the distance between the inside wall surface of the first flat-plate portion 11 and the inside wall surface of the second flat-plate portion 12 and the distance between the inside wall surface of the third flat-plate portion 13 and the inside wall surface of the fourth flat-plate portion 14 can be each about 0.1 to about 5.0 mm. Furthermore, the thickness of the glass tube 10 can be, for example, about 0.05 to 2.5 mm. Moreover, the length of the glass tube 10 in the y direction can be about 2 to about 1000 mm.

No particular limitation is placed on the type of glass forming the glass tube 10. Examples that can be used as the glass tube 10 include silicate-based glasses, borate-based glasses, phosphate-based glasses, borosilicate-based glasses, and borophosphate-based glasses. Particularly preferred among them are silicate-based glasses and borosilicate-based glasses that have excellent transparency and can increase the light extraction efficiency.

For example, quantum dots can be used as the phosphor 2.

Examples of such quantum dots that can be cited include group II-VI compounds and group III-V compounds. Examples of such group II-VI compounds that can be cited include CdS, CdSe, CdTe, ZnS, ZnSe, and ZnTe. Examples of such group III-V compounds that can be cited include InP, GaN, GaAs, GaP, AlN, AlP, AlSb, InN, InAs, and InSb. At least one or a composite of two or more selected from the above compounds can be used as the quantum dots. Examples of such composites that can be cited include those having a core-shell structure, for example, a composite having a core-shell structure in which the surfaces of CdSe particles are coated with ZnS.

The particle diameter of the quantum dots is appropriately selected within a range of, for example, 100 nm or less, preferably 50 nm or less, particularly preferably 1 to 30 nm, more preferably 1 to 15 nm, or still more preferably 1.5 to 12 nm.

The quantum dots are preferably introduced as a dispersion in a resin into the glass tube 10. Examples of such resins to be used include ultraviolet curable resins and thermosetting resins. Specifically, for example, epoxy-based curable resins, acrylic ultraviolet curable resins, and silicone-based curable resins can be used. These resins are preferred because they are resins having fluidity during the introduction.

The phosphor 2 used is not limited to quantum dots and, for example, particles of an inorganic phosphor, such as oxide phosphor, nitride phosphor, oxynitride phosphor, chloride phosphor, oxychloride phosphor, sulfide phosphor, oxysulfide phosphor, halide phosphor, chalcogenide phosphor, aluminate phosphor, halophosphoric acid chloride phosphor, or garnet-based compound phosphor, may be used.

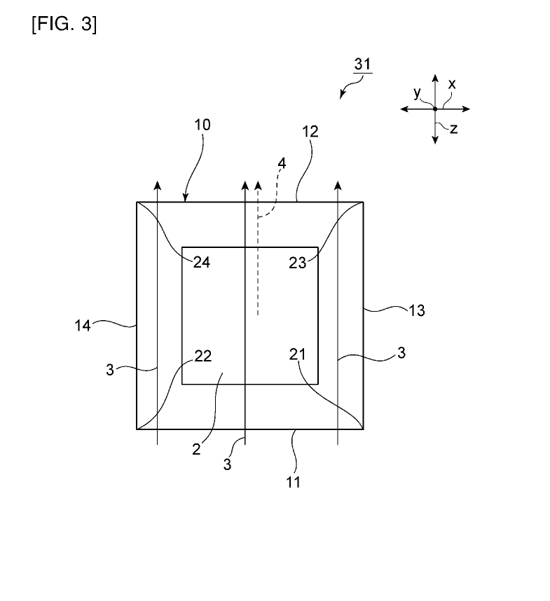

FIG. 3 is a schematic transverse cross-sectional view showing a conventional wavelength conversion member. As shown in FIG. 3, in a conventional wavelength conversion member 31, a first corner 21, a second corner 22, a third corner 23, and a fourth corner 24 are not chamfered. As shown in FIG. 3, in the case of the conventional wavelength conversion member 31, excitation light 3 having entered the third flat-plate portion 13 and the fourth flat-plate portion 14 does not enter the phosphor 2 and is emitted from the wavelength conversion member 31 as it is. On the other hand, excitation light 3 having passed through the first flat-plate portion 11 and entered the phosphor 2 is partly converted in wavelength by the phosphor 2, passes as fluorescence 4 through the second flat-plate portion 12, and is then emitted to the outside. Furthermore, part of the excitation light 3 is not converted in wavelength, passes through the second flat-plate portion 12 as it is, and is then emitted to the outside. Therefore, the fluorescence and the excitation light 3 are emitted through the second flat-plate portion 12 to the outside, so that a synthetic light of the fluorescence 4 and the excitation light 3, for example, a white light, is emitted to the outside. As described above, excitation light 3 having entered the third flat-plate portion 13 and the fourth flat-plate portion 14 is emitted from the wavelength conversion member 31 as it is. Therefore, there arises the problem that because the excitation light 3 emitted through the third flat-plate portion 13 and the fourth flat-plate portion 14 to the outside is added to the synthetic light of fluorescence 4 and excitation light 3 emitted through the second flat-plate portion 12 to the outside, a predetermined color balance of the synthetic light cannot be achieved.

In the wavelength conversion member 1 according to this embodiment, as shown in FIG. 2, the first corner 21 and the second corner 22 are chamfered and thus formed with the inclined surface and the inclined surface 16, respectively. Therefore, excitation light 3 entering the third flat-plate portion 13 and the fourth flat-plate portion 14 is refracted by the inclined surface 15 and the inclined surface 16 to change the direction of travel and enters the phosphor 2. Thus, part of the excitation light 3 is converted in wavelength and emitted as fluorescence 2 to the outside. Therefore, the excitation light 3 having entered the third flat-plate portion 13 and the fourth flat-plate portion 14 is also emitted as a synthetic light of fluorescence 4 and excitation light 3 to the outside, so that, unlike the conventional wavelength conversion member 1, the deterioration of the color balance of emitted light can be reduced. Hence, this embodiment enables to improve the color balance of emitted light.

In this embodiment, the third corner 23 and the fourth corner 24 both located on the light exit side are also chamfered. However, the third corner 23 and the fourth corner 24 both located on the light exit side do not always have to be chamfered. By chamfering the third flat-plate portion 23 and the fourth flat-plate portion 24, any flat-plate portion of the glass tube 10 can be disposed on the light incident side to serve as the first flat-plate portion 11, so that the glass tube 10 becomes easy to handle.

Furthermore, although in this embodiment both the first corner 21 and the second corner 22 are chamfered, the present invention is not limited to this and it is sufficient that at least one of the first corner 21 and the second corner 22 is chamfered.

Although in this embodiment a so-called C-chamfering is made as the chamfering, the present invention is not limited to this. Any chamfering will work if it enables at least part of excitation light 3 entering the third flat-plate portion 13 and the fourth flat-plate portion 14 to be refracted by the incident surface to enter the phosphor 2. For example, a so-called R-chamfering may be made which forms a curved surface on the corner.

In the case of chamfering resulting in the formation of an inclined surface, the angle of inclination of the inclined surface is preferably in a range of 30 to 60° to the x direction and more preferably in a range of 40 to 50° to the x direction. By employing such a range, excitation light 3 incident on the third flat-plate portion 13 and the fourth flat-plate portion 14 becomes likely to enter the phosphor 2.

No particular limitation is placed on the method for producing the wavelength conversion member 1 according to this embodiment. For example, the wavelength conversion member can be produced by the following method. A glass tube 10 is prepared in which an end 10a is sealed and an end 10b is open. A phosphor 2 is introduced though the open end 10b into the glass tube 10, thus filling the inside of the glass tube 10 with the phosphor 2. Specifically, the end 10b of the glass tube 10 is put into a phosphor 2 in fluid state while the inside of the glass tube 11 is kept under reduced pressure, so that the phosphor 2 can be introduced into the glass tube 10. In this embodiment, since quantum dots dispersed in a resin are used as the phosphor 2, the resin during introduction of the phosphor 2 is uncured and therefore has fluidity. After the phosphor 2 is introduced into the glass tube 10, the resin around the phosphor 2 is cured by ultraviolet irradiation or other means. Thereafter, by fusing the glass or using another member, the open end 10b is sealed.

### REFERENCE SIGNS LIST

1, 31 . . . wavelength conversion member

2 . . . phosphor

3 . . . excitation light

4 . . . fluorescence

10 . . . glass tube

10a, 10b . . . end

11 . . . first flat-plate portion

12 . . . second flat-plate portion

13 . . . third flat-plate portion

14 . . . fourth flat-plate portion

15, 16, 17, 18 . . . inclined surface

21 . . . first corner

22 . . . second corner

23 . . . third corner

24 . . . fourth corner

1. A wavelength conversion member in which a phosphor is encapsulated within a glass tube,
the glass tube comprising:
a first flat-plate portion and a second flat-plate portion opposed to each other in a first direction perpendicular to a longitudinal direction of the glass tube; and
a third flat-plate portion and a fourth flat-plate portion opposed to each other in a second direction perpendicular to both the longitudinal direction of the glass tube and the first direction,
the first flat-plate portion being located on a light incident side of the glass tube through which excitation light for exciting the phosphor enters the glass tube, the second flat-plate portion being located on a light exit side of the glass tube through which fluorescence from the phosphor is emitted from the glass tube,
at least one of a first corner connecting between the first flat-plate portion and the third flat-plate portion and a second corner connecting between the first flat-plate portion and the fourth flat-plate portion being chamfered.

2. The wavelength conversion member according to claim 1, wherein both the first corner and the second corner are chamfered.

3. The wavelength conversion member according to claim 1, wherein a third corner connecting between the second flat-plate portion and the third flat-plate portion and a fourth corner connecting between the second flat-plate portion and the fourth flat-plate portion are chamfered.

4. The wavelength conversion member according to claim 1, wherein the phosphor is quantum dots.

5. The wavelength conversion member according to claim 4, wherein the quantum dots are encapsulated as a dispersion in a resin within the glass tube.
